(19) United States
(12) Patent Application Publication
(10) Pub. No.: US 2010/0100704 A1
(43) Pub. Date: Apr. 22, 2010

(54) Integrated circuit incorporating an array of interconnected processors executing a cycle-based program

(75) Inventors: Stephen John Hill, Grantchester (GB); Michael Peter Muller, Cambridge (GB)

Correspondence Address: NIXON & VANDERHYE P.C., 901 N. Glebe Road, 11th Floor, Arlington, VA, 22203-1808, US

(73) Assignee: ARM Limited, Cambridge (GB)

(21) Appl. No.: 12/588,413

(22) Filed: Oct. 14, 2009

(30) Foreign Application Priority Data
Oct. 22, 2008 (GB) 0819373.2

(51) Int. Cl. G06F 15/80; G06F 9/02; G06F 9/38

(52) U.S. Cl. 712/19; 712/233; 712/E09.002; 712/E09.045

(57) ABSTRACT

An integrated circuit 4 is provided including an array 10 of processors 26 with interface circuitry 12 providing communication with further processing circuitry 14. The processors 26 within the array 10 execute individual programs which together provide the functionality of a cycle-based program. During each program-cycle of the cycle based program, each of the processors executes its respective program starting from a predetermined execution start point to evaluate a next state of at least some of the state variables of the cycle-based program. A boundary between program-cycles provides a synchronisation time (point) for processing operations performed by the array.

### BACKGROUND OF THE INVENTION

1. Field of the Invention

This invention relates to the field of integrated circuits. More particularly, this invention relates to integrated circuits incorporating an array of interconnected processors executing a cycle-based program.

2. Description of the Prior Art

It is known to provide integrated circuits for performing data processing tasks. These integrated circuits have rapidly increased in capability and complexity. It is also known to provide desired data processing functionality in the form of either a program executing on a general purpose processor or using special purpose dedicated hardware. The approach of a program executing on a general purpose processor has the advantage of flexibility in that it is possible to relatively readily modify the program and so adapt the processing performed. As an example, if the program is performing some data encryption or decryption processing and the method of encryption or decryption is modified during the service life of the integrated circuit, then it is possible to modify the program being executed to take account of the change. However, using a program executing on a general purpose processor is generally slower and less power efficient than using dedicated hardware. Dedicated hardware can be tuned and optimised to perform a specific processing function. Such dedicated hardware, such as an encryption engine or a decryption engine, can deliver high performance with relatively low power consumption compared to a program executing on a general purpose processor. However, such dedicated hardware has the disadvantage of being relatively inflexible and generally unmodifiable during the service life of the integrated circuit so as to adapt to changing processing requirements.

Another situation in which there is a trade off between software implemented processing and dedicated hardware support is where a number of variants of an integrated circuit are required. The costs associated with developing and manufacturing an integrated circuit are high. If dedicated hardware is used in order to benefit from its high speed and low power consumption, then different integrated circuits need to be manufactured for each differing variant so as to provide the different hardware support required. This increases cost. Accordingly, it may be desirable in such circumstances to provide desired functionality via software executing on a processor, even though this may be relatively slower and less power efficient.

A further problematic scenario is wherein an integrated circuit is developed and manufactured at considerable expense and then the desired functionality of that integrated circuit is changed. At the time the integrated circuit was designed and manufactured there may have been no need for a particular form of functionality. However, during the lifetime of that integrated circuit in manufacture such a need may arise. In order to avoid the cost of having to adapt the manufacturing process it may be preferable in these circumstances to provide the new desired functionality in the form of software rather than using dedicated hardware. This software implementation will generally have lower performance and higher power consumption, but this may be preferable to the costs of developing a new integrated circuit. It may also be possible to modify existing end-user devices that are in-field via a software update whereas it is much more problematic to replace integrated circuits within those end user devices in order to provide the desired new functionality.

### SUMMARY OF THE INVENTION

Viewed from one aspect the present invention provides an integrated circuit for data processing, said integrated circuit comprising: an array of interconnected processors, each processor having a memory storing a program defining a set of processing operations to be performed by said processor; further processing circuitry responsive to a synchronous clock signal to perform synchronous processing operations; and interface circuitry coupled to said array and to said further circuitry to provide communication of one or more signals between said array and said further processing circuitry such that data processing operations of said integrated circuit are distributed between said array and said further processing circuitry; wherein said programs stored within said memories of said array together define a plurality of sets of processing operations to be performed by said processors of said array such that said array is configured to execute a cycle-based program; said cycle-based program provides state variables that allow results of operations executed in one program-cycle of said cycle-based program to be accessed during a subsequent program-cycle of said cycle-based program; and during each program-cycle of said cycle-based program, each of said processors of said array executes a respective program starting from a predetermined execution start point to evaluate a next state of at least some of said state variables, a boundary between program-cycles providing a synchronisation time for processing operations performed by said array.

The present technique provides within an integrated circuit a combination of an array of interconnected processors each having a memory storing a program for that processor, and the array communicating via interface circuitry with further processing circuitry responsive to a synchronous clock signal to perform its own synchronous processing operations. The array of inteconnected processors and the further processing circuitry thus cooperate to achieve the overall desired functionality of integrated circuit concerned. The processors of the array are programmed such that the array is configured to execute a cycle-based program. The cycle-based program provides state variables that allow operations executed in one program-cycle of the cycle-based program to be accessed during a subsequent program-cycle of the cycle-based program. The cycle-based program provides the desired functionality by establishing what processing operations need to be performed in each program-cycle to generate desired output state variables from the available input state variables. This processing is then divided between the different processors of the array. Each processor in the array executes its own program starting from a predetermined execution start point at the beginning of each evaluation cycle so as to evaluate the next state of at least some of the state variables. Each processor of the array executes its same program starting from the same point during each program-cycle, although the path through that program may vary. The boundary between program-cycles provides a synchronisation time for the processing operations performed by the array.

Dividing the processing to be performed between different processors within such an array allows a high degree of parallelism. The cycle-based program simplifies the programming of the array. The programming of parallel processing is notoriously difficult. However, when a user is seeking to provide such processing in place of dedicated hardware, it is normal for the designers of such dedicated hardware to already have a clear view of the processing operations which need to be performed in parallel during each cycle by the dedicated hardware. Using this understanding of how the dedicated hardware would be provided allows a cycle-based program to be formed and partitioned between different processors of the array in a manner which allows a good balance between processor performance and power consumption to be achieved in providing the required functionality using the array. Hardware engineers are used to partitioning the processing to be required into different sections which can be performed in parallel by the hardware. Much hardware design is performed using design languages, such as register transfer level Verilog or synthesisable Verilog, which utilise an explicit clock signal and define the operations to be performed in parallel during each clock cycle. This type of understanding and existing infrastructure can be utilised in forming the cycle-based programs for the processors of the array. Each processor of the array executes its individual program during a program-cycle to produce its output state variables from its input state variables. The values of state variables and temporary (non-state) variables required by processors that do not produce them are transmitted across the array communication links during execution. The program-cycles correspond to clock cycles within hardware. In the same way that a hardware element will perform the same processing on each clock cycle, so will a processor within the array execute the same program on each program-cycle.

The interface circuitry communicating with the further processing circuitry driven by the synchronous clock signal can take a variety of different forms. These different forms may be used separately or in combination. The different forms include a synchronous clocked bus of the further processing circuitry, an asynchronous bus of the further processing circuitry, handshake circuitry providing communication in accordance with a handshake protocol, circuitry responsive to a signal from the array to be communicated to the further processing circuitry which maintains a signal level of a signal being passed to the further processing circuitry for a predetermined number of cycles of the synchronous clock signal, circuitry responsive to a signal from the array to be communicated to the further processing circuitry that alters a signal level of the signal being passed to the further processing circuitry after a predetermined number of cycles of the synchronous clock signal; and/or circuitry that samples a signal from said further processing circuitry at a predetermined time relative to said synchronous clock signal and then passes said signal to said array synchronised with a clock signal of said array. These different interface mechanisms have different strengths and weaknesses. For example, utilisation of the synchronous bus may more readily provide predictable levels of performance. The use of an asynchronous bus may give more flexibility in incorporating the desired communication within the overall processing being performed on the integrated circuit. The use of the circuitry which holds a signal for a predetermined number of cycles of the synchronous clock signal, or alters the signal after a predetermined number of cycles, provides a mechanism for ensuring appropriate capture of a signal being passed to the further processing circuitry operating with the synchronous clock signal.

The programs being executed by the processors of the array have the characteristics of software programs as contrasted with the characteristics of static or time varying hardware configuration. In at least preferred embodiments, the programs of the processors of the array may include branch programming instructions for permitting non-sequential program flow, variable length instructions for permitting higher program density and/or program instructions which take different numbers of clock cycles of the processors of the array to execute in recognition of the different levels of processing complexity which may be associated with different program instructions.

The processors of the array will typically be relatively simple processors since they are only being required to repeatedly perform execution of one program which itself only forms part of the overall desired processing. The simple form of the processors of the array can allow them to execute with a high frequency array clock signal which can be greater in frequency than the synchronous clock signal used by the further processing circuitry. Thus, the processors of the array may perform many processing cycles to achieve their desired portion of the overall processing being provided by the array during a single clock cycle of the synchronous clock signal of the further processing circuitry.

It may be that the program-cycles of the array are synchronised with the synchronous clock signal in some fixed manner. This can facilitate communication between the array and the further processing circuitry. It is also possible that the program-cycles may be permitted to have a variable duration while the interface circuitry still continues to communicate with the further processing circuitry in a manner synchronised with the synchronous clock. This may permit the array to enter, for example, a low power mode when high performance is not required. A further example would be altering the program-cycle duration to match the amount of processing to be performed.

The processors within the array can provide a multi-bit data path way for processing a multi-bit data value. It is often the case that when processing operations to be performed in parallel are portioned out that the same processing operation will be required in respect of different bits within a multi-bit value and this may be conveniently and efficiently performed utilising a processor within an array that supports such a multi-bit pathway.

The interface circuitry between the array and the further processing circuitry may in some embodiments use a system bus which is open to use for communication within the integrated circuit that does not involve the array. The array thus can act as a master or slave device attached to the system bus utilising communication infrastructure that is already provided.

In other embodiments, the interface circuitry can provide communication to the further processing circuitry via a private bus dedicated to communication between the array and the further processing circuitry. This arrangement permits a more tightly-coupled association to be achieved and provides more predictable levels of performance and potentially higher performance than utilising an open system bus.

The programs for the array may be conventionally machine generated from a machine readable hardware description of hardware having functionality to be provided by the array. As previously mentioned, it is known for hardware engineers to design dedicated hardware using machine readable hardware descriptions. Various software tools are conventionally used to then convert these machine readable hardware descriptions into gate level implementations of the desired hardware. This process is normally referred to as hardware synthesis. With the present technique, the same machine readable hardware descriptions may be utilised to generate the programs for the processors of the array in a technique analogous to software compilation. The hardware descriptions are typically already in a form with an explicit clock which facilitates partitioning between the processors of the array and effective parallisation of the processing being performed. Examples of the machine readable hardware description include register transfer level Verilog and synthesisable Verilog.

The reusability and flexibility of the array within the integrated circuit is facilitated when the memories of the processors within the array are rewritable. Whilst it might be possible to use non-rewritable memories in some circumstances, rewritable memories for the processors within the array permits them to be reprogrammed and permits them to be readily used for temporary data storage during each program-cycle.

It will be appreciated that the further processing circuitry can take a wide variety of different forms. These may include, for example, a general purpose program controlled processor, a digital signal processor, a non-programmable processing engine and a memory.

Viewed from another aspect the present invention provides a method of programming an integrated circuit having an array of interconnected processors, each processor having a memory storing a program comprising a set of processing operations to be performed by said processor, and further processing circuitry responsive to a synchronous clock signal to perform synchronous processing operations, said method comprising the steps of: generating a synthesisable hardware description with at least one explicit clock signal to perform desired processing; mapping said hardware description to a plurality of programs each defining a set of processing operations to be performed by a processor within said array; and storing said plurality of programs in respective program memories within said array such that: said array when executing said plurality of programs executes a cycle-based program corresponding to said desired processing described in said hardware description; said cycle-based program provides state variables that allow results of operations executed in one program-cycle of said cycle-based program to be accessed during a subsequent program-cycle of said cycle-based program; and during each program-cycle of said cycle-based program, each of said processors of said array executes a respective program starting from a predetermined execution start point to evaluate a next state of at least some of said state variables, a boundary between program-cycles providing a synchronisation time (or point) for processing operations performed by said array.

Viewed from a further aspect the present invention provides an end-user device including an integrated circuit for data processing, said integrated circuit comprising: an array of interconnected processors, each processor having a memory storing a program defining a set of processing operations to be performed by said processor; further processing circuitry responsive to a synchronous clock signal to perform synchronous processing operations; and interface circuitry coupled to said array and to said further circuitry to provide communication of one or more signals between said array and said further processing circuitry such that data processing operations of said integrated circuit are distributed between said array and said further processing circuitry; wherein said programs stored within said memories of said array together define a plurality of sets of processing operations to be performed by said processors of said array such that said array is configured to execute a cycle-based program; said cycle-based program provides state variables that allow results of operations executed in one program-cycle of said cycle-based program to be accessed during a subsequent program-cycle of said cycle-based program; and during each program-cycle of said cycle-based program, each of said processors of said array executes a respective program starting from a predetermined execution start point to evaluate a next state of at least some of said state variables, a boundary between program-cycles providing a synchronisation time for processing operations performed by said array.

Viewed from a further aspect the present invention provides a method of providing an in-field update to functionality of an integrated circuit having an array of interconnected processors, each processor having a memory storing a program comprising a set of processing operations to be performed by said processor, and further processing circuitry responsive to a synchronous clock signal to perform synchronous processing operations, said method comprising the steps of: generating a synthesisable hardware description with at least one explicit clock signal to perform desired processing; mapping said hardware description to a plurality of programs each defining a set of processing operations to be performed by a processor within said array; and storing said plurality of programs in respective program memories within said array such that: said array when executing said plurality of programs executes a cycle-based program corresponding to said desired processing described in said hardware description; said cycle-based program provides state variables that allow results of operations executed in one program-cycle of said cycle-based program to be accessed during a subsequent program-cycle of said cycle-based program; and during each program-cycle of said cycle-based program, each of said processors of said array executes a respective program starting from a predetermined execution start point to evaluate a next state of at least some of said state variables, a boundary between program-cycles providing a synchronisation time for processing operations performed by said array.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates an end-user device incorporating an integrated circuit;

FIG. 2 schematically illustrates an integrated circuit incorporating an array of processors and further processing circuitry;

FIG. 3 schematically illustrates in an array of processors;

FIG. 4 schematically illustrates an individual processor from within an array of processors;

FIGS. 5a, 5b, 5c, 5d and 5e schematically illustrates a relationship between a simple C program, a pseudo-code cycle-based program performing the same function as the C program, the dependencies between the instructions within the pseudo-code program, the partitioning of the pseudo-code programs in to two sub-programs for running on two processors and a pseudo-code execution trace;

FIGS. 6A, 6B and 6C illustrates a relationship between a synchronous clock signal (system clock signal), an array clock signal and an program-cycle; and

FIG. 7 is a flow diagram schematically illustrating the programming of an array of processors.

### DESCRIPTION OF THE PREFERRED EMBODIMENTS

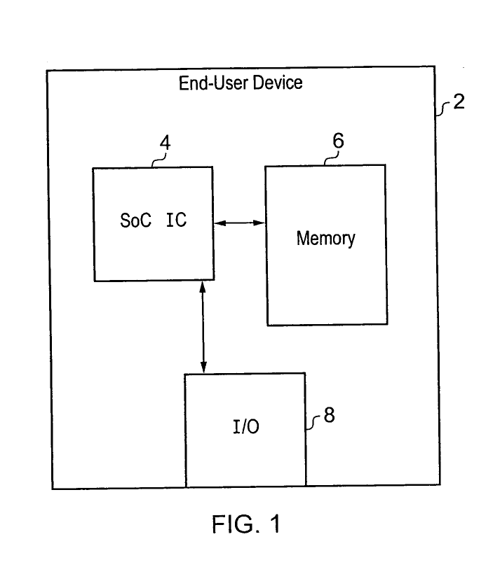

FIG. 1 illustrates an end-user device 2 incorporating a system-on-chip integrated circuit 4 communicating with a memory 6 and input/output circuitry 8. It will be appreciated that the end-user device could have a wide variety of different forms. For example, the end-user device could be a mobile telephone, a portable computer, a control system within an automobile, a control system within a television set or many other end-user devices.

The memory 6 stores data and programs for manipulation or use by the integrated circuit 4. Communication with devices external of the end-user device 2 is performed by the input/output circuitry 8.

Subsequent to initial design, or during in-field use, it may be that the functionality required of the integrated circuit 4 changes. For example, a new encryption algorithm may need to be supported, or a new format of media data may need to be decoded. Some of these new requirements may be accommodated by reprogramming of the software controlling a general purpose processor within the integrated circuit 4. However, such a general purpose processor may not provide processing of sufficiently high performance or of sufficiently high efficiency compared with a dedicated hardware implementation of the new functionality.

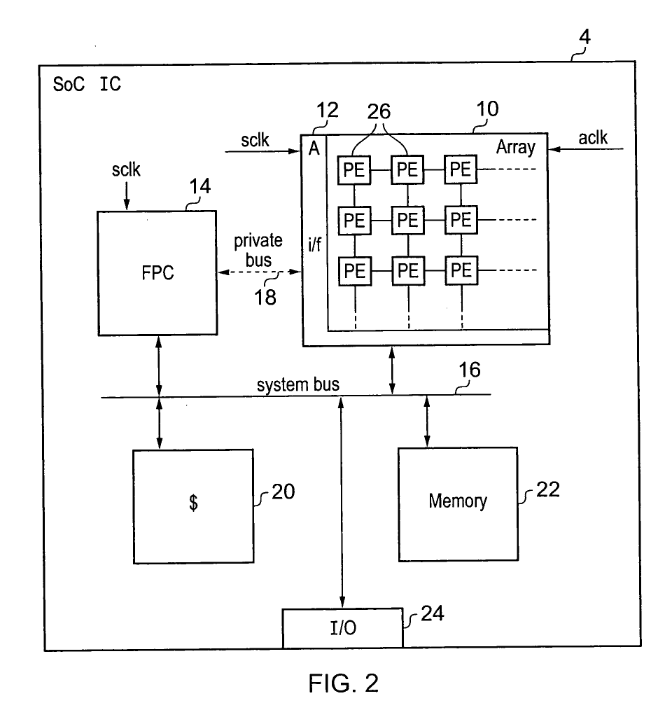

FIG. 2 schematically illustrates the integrated circuit 4 in more detail the integrated circuit 4 includes an array of processors 10, interface circuitry 12 and further processing circuitry 14. The array of processors 10 communicates via the interface circuitry 12 with the further processing circuitry 14 using a system bus 16. It is also possible in some embodiments to utilise a private bus (and/or individual signals) 18 running directly between the interface circuitry 12 and the further processing circuitry 14. A cache memory 20, a main memory 22 and input/output circuitry 24 are also connected to the system bus 16 and may communicate with the further processing circuitry 14 and with each other without involvement of the array 10.

The further processing circuitry 14, the cache memory 20, the main memory 22 and the input/output circuitry 24 are all driven by a system clock signals sclk (serving as the synchronous clock signals mentioned above) [AJ1]distributed throughout the integrated circuit 4. The array 10 has its own higher frequency array clock signal aclk which is used to control an array of processors 26. These processors 26 are interconnected. There are shown local connections from processors within the array to their North, South, East and West neighbours. It is also possible that non-local interconnections may be provided between processors which are spaced further apart.

The interface circuitry 12 receives the system clock signal sclk and signals from the array 10. The interface circuitry 12 manages communication between the further processing circuitry 14 and the processors 26 within the array 10. This communication may be via the system bus 16 or the private bus 18. Communication via the system bus 16 or private bus 18 may be synchronous or asynchronous. When operating asynchronously, instead of sclk the bus can use asynchronous circuitry, e.g. asynchronous-handshake circuitry (no sclk) or it may simply be that sclk is not synchronised with aclk. Synchronous communication has advantages such as predictability, whereas asynchronous communication may be more flexible and adaptable. It is also possible that both types of communication may be supported.

The interface circuitry 12 may output a value received from the cycle-based-program to the further processing circuitry 14 quickly as possible. Similarly it may make values from the further processing circuitry 14 available to the cycle-based-program as quickly as possible.

Alternatively, the interface circuitry 12 may synchronise outputs to further processing circuitry 14 to sclk or to a number of aclk cycles after an sclk edge.

Similarly, inputs from the further processing circuitry 14 may be sampled on an sclk edge or to a number of aclk cycles after an sclk edge.

Alternatively, the interface circuitry 12 may be signalled to outputs values to the further processing circuitry 14 for a number of aclk cycles after an sclk edge.

Similarly, inputs from the further processing circuitry 14 may be sensitive for a number of aclk cycles after an sclk edge.

The interface circuitry 12 may be send a set of output values to output to the further processing circuitry 14 in sequence advanced by sclk or aclk edges.

Similarly, inputs from the further processing circuitry 14 may be sampled more than once per program-cycle, the set of samples being available to the cycle-based program.

The interface circuitry 12 may be configured to hold its output values unless a new value is sent to it by a deadline specified relative to aclk or sclk.

Similarly, inputs of the interface circuitry 12 from the further processing circuitry 14 may be configured to sample a new value only if it arrives from the further processing circuitry 14 by a deadline specified relative to aclk or sclk.

Inputs from the further processing circuitry 14 may be monitored for certain values and a transition to those values reported to the cycle-based program even if the values subsequently changes to other values before the cycle-based program reads the input.

When a handshake is used to connect the further processing circuitry 14 to the array, the interface circuitry 12 may take care of part or all of the handshake protocol. At one extreme, the interface circuitry 12 takes values to be communicated from the array and performs an entire handshake controlled transfer to the further processing circuitry 14 or visa-versa. At the other extreme, the interface circuitry 12 passes the values of the handshake control signals to the array and the cycle-based program on the array performs the handshake protocol.

In some implementations the interface circuitry 12 can also buffer communications from the array to the further processing circuitry 14 or from the further processing circuitry 14 to the array. Values are inserted into a buffer according to one clock or protocol and removed from the buffer according to the other clock or protocol.

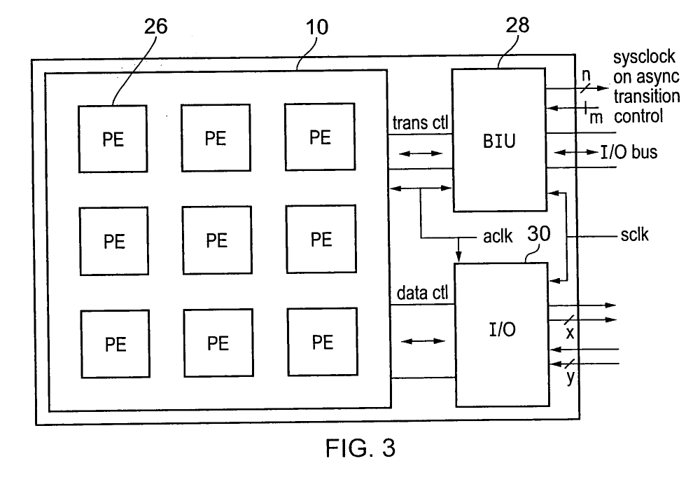

FIG. 3 schematically illustrates the array 10 in more detail. In particular, the interface circuitry 12 is shown as including a bus interface unit 28 and an input/output unit 30. The bus interface unit 28 is responsible for communication with bus transactions using either the system bus 16 or the private bus 18. These transactions may be synchronous with the array clock aclk or asynchronous. The transactions may pass data or control in either direction. The bus interface unit 28 is responsive to the array clock signal aclk as well as the system clock signal sclk.

The input/output unit 30 is responsible for passing signals to and from the array 10 that are not bus transactions. These signals may, for example, be interrupt signals or control signals. The input/output unit 30 is responsible for holding an output signal to the further processing circuitry 14 for a predetermined number of aclk clock signal cycles (with the delay counted in aclk or sclk cycles) or for altering such a signal after a predetermined number of system clock signal cycles as previously discussed. Handshaking circuitry and protocols may also be used.

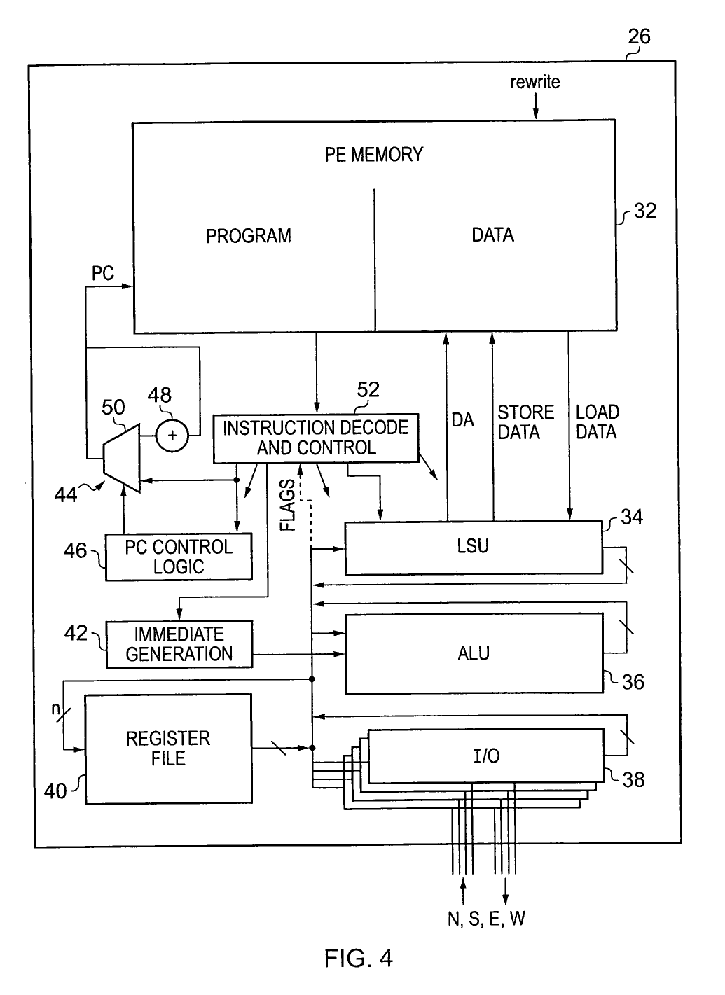

FIG. 4 schematically illustrates a processor 26 of the array 10 in more detail. The processor 26 includes a memory 32 storing both the program to be executed by the processor 26 as well as providing data storage for use by variables of the processing performed by the processor 26. The memory 32 may be partitioned to allow simultaneous access to multiple instruction or data values. Use for Instruction or Data may be fixed or variable. The processor 26 further includes a load store unit 34 for loading data to and from the memory 32. An arithmetic logic unit 36 performs arithmetic or logical operations as specified by program instructions retrieved from the memory 32 upon data values. Interconnect circuitry 38 serves to provide North, South, East and West local connections to other processors 26 within the array 10 as well as non-local connection. The processors 26 are interconnected and can exchange signals both at program-cycle boundaries and at fixed offsets from such boundaries.

The processor 26 further includes a register file 40 for storing values used frequently in processing manipulations. An immediate generator circuit 42 is responsive to decoded instructions to generate immediate values for use in data manipulations. Such immediate values are specified by the program instructions being manipulated, as will be familiar to those in this technical field. The memory 32 is addressed to retrieve program instructions for execution by the processor 26 using program counter circuitry 44 which includes PC control logic 46, an incrementer 48 and a multiplexer 50. The PC control logic 46 responds to branch instructions to trigger a non-sequential jump of program flow to a branch target by an appropriate manipulation of the program counter value. In normal sequential program flow the incrementer 48 is used to advance the program counter (by an amount dependent upon the current instruction length) as each program instruction to be executed by the processor 26 is required. An instruction decoder 52 decodes program instructions fetched from the memory 34. These program instructions may be variable length program instructions so as to improve code density. The program instructions may also take variable numbers of array clock cycles to execute with the program counter value PC being changed after the appropriate number of array clock signal cycles. The instruction decoder 52 controls the immediate generator circuitry 42 and other circuit elements when an instruction specifying an immediate value is encountered. Furthermore, flag signals generated by at least the arithmetic logic unit 36 can be used to modify the behaviour of the instruction decoder 52. For example, a conditional branch instruction may trigger a branch when the result of a preceding data processing operation performed by the arithmetic logic unit produces a zero value. Further types of flags such as non-zero, carry, overflow etc will be familiar and can be used by the instruction decoder 52 depending upon the level of complexity thereof.

The program stored within the memory 32 is executed from a predetermined start point for each program-cycle. The path followed through the program may vary. In some program-cycles no processing may be required by that processor 26 and accordingly the processing path will be very short with the processor spending most of its time waiting for the start of the next evaluations cycle. In other program-cycles, complex processing may be required which only completes just before the end of the program-cycle. In each program-cycle, the program executed can be considered as manipulating input state variables to generate output state variables in a manner equivalent to what would be achieved by a corresponding portion of a dedicated hardware implementation of the functionality concerned. The individual processors within the array are responsible for repeatedly executing their own individual programs to achieve the functionality of a small portion of hardware which would otherwise be used in a dedicated hardware implementation. The processors 26 as a consequence of their relative simplicity can operate with a high array clock signal frequency with many array clock signal cycles corresponding to a signal program-cycle and/or a single system clock cycle.

The processors 26 within the array 10 as a whole together serve to execute a cycle-based program which is performing the desired overall functionality of manipulating state variables at each program-cycle to determine the value of those state variables for the next program-cycle. This is analogous to the way in which synchronous hardware evaluates in each clock signal to generate circuit state characterising the outcome of the current cycle starting from the state which characterise the outcome cycle.

The processor 26 manipulates multi-bit data values with, for example, the arithmetic logic unit 26 supporting multi-bit arithmetic operations and multi-bit logical operations. Similarly, the load store unit 34 can perform store data operations and load data operations to and from the memory 34 in relation to multi-bit data values. In practice, many desired processing operations have such multi-bit characteristics which are more effectively supported by processors 26 having a multi-bit capability.

The memory 32 is rewritable. This permits in-field reprogramming of the processors 26. The reprogramming of the memory 32 may be achieved in a variety of different ways. A separate reprogramming channel may be provided. Alternatively, the reprogramming could take place under control of one of the processors 26 within the array 10.

Returning to FIG. 2, it will be appreciated that the further processing circuitry 14 can have a variety of different forms. For example, it may be in the form of a general purpose program controlled processor, a digital signal processor, a non-programmable processing engine or a memory. The integrated circuit 4 may or may not include further elements.

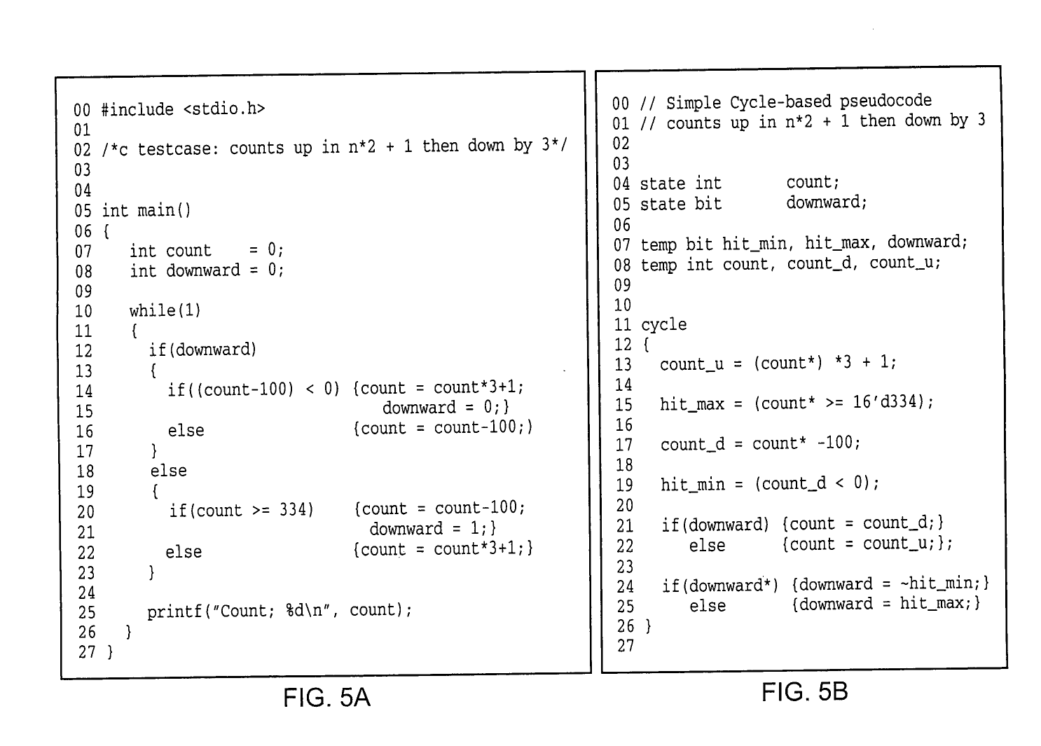

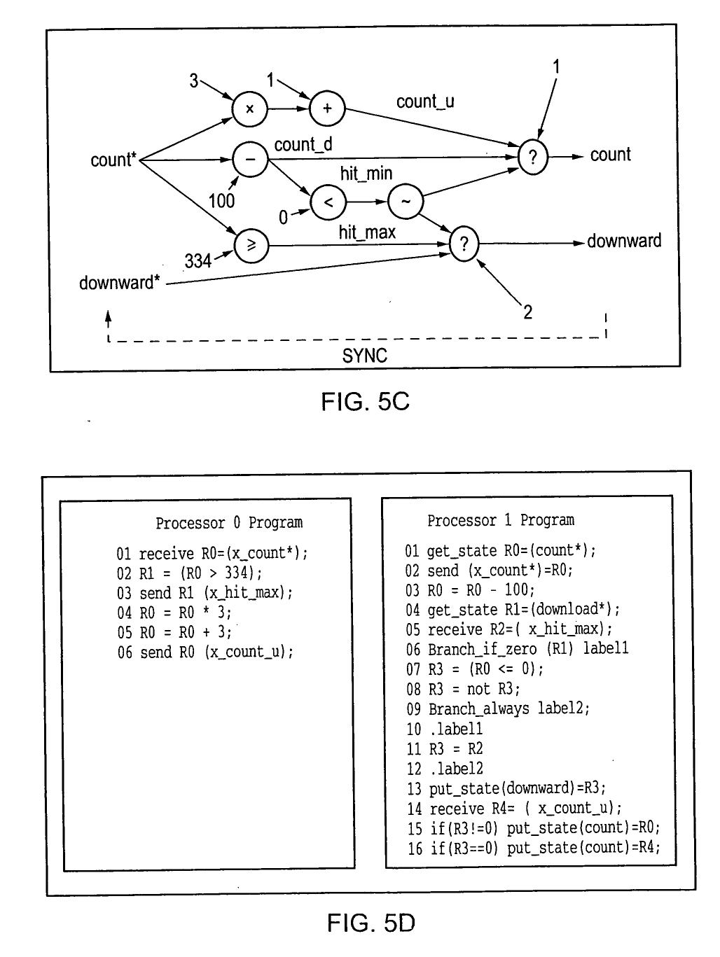

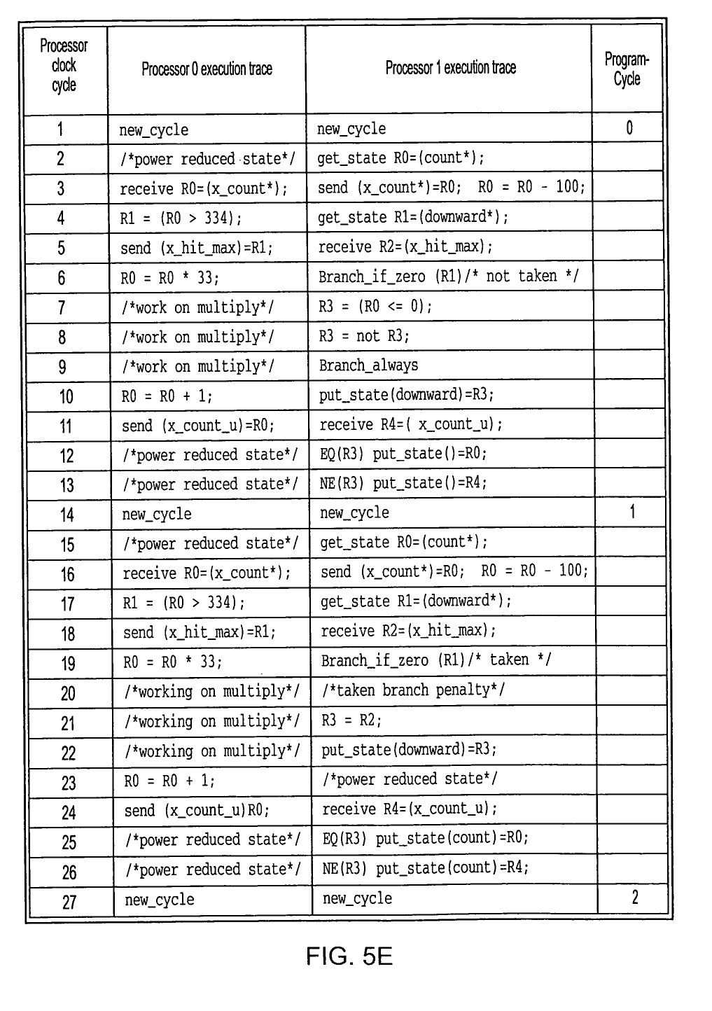

FIG. 5a is a simple C program that performs the same function as the cycle-based pseudo-code in FIG. 5b. It is presented only for the purpose of aiding understanding of the testcase. The cycle-based code is not derived from a C program. The program counts up to a limit and then down to zero and then up again repeatedly. When counting up, the count increases to the current count multiplied by 3 plus 1. When counting down the count is decreased by 100.

The C language is such that the instructions in the program execute in the order they appear in the program, so for example, when all the “if ” condition evaluate true:

The “if” at line 12 evaluates before

the “if” at line 14 which evaluates before

the “count=count*3+1” at line 14 which evaluates before

the “downward” at line 15 . . .

Note: the C program includes a printf function call to print the result to the screen. This is not included in the cycle-based pseudo-code in FIG. 5b.

FIG. 5b shows the pseudo-code for a cycle-based program that performs the same count as FIG. 5a.

Lines 11, 12 and 26 delimit the block of instructions that capture the desired function of the program. The instructions between lines 11 and 25 are describe desired function of the program not the order in which to execute them. Instead the instructions may be evaluated in any order that satisfies the dependencies between them (See FIG. 5c). Note: that the entire “if . . . else . . . ” on lines 21 and 22 is considered one instruction for the purposes of ordering. Similarly the “if . . . else . . . ” at lines 24, 25.

A processor running this cycle-based program repeatedly evaluates the operations between lines 11 and 25. Each evaluation corresponds to a program-cycle of an element in the array. In some applications this re-evaluation is allowed to continue indefinitely i.e. until power is removed or the processor is reset. In other applications an “exit” instruction is implemented (not shown in this pseudo-code) and this can be used by a program to signal it wishes to stop executing.

Lines 4 and 5 declare state variables that are used to send information from one program-cycle to the next. The value of a passed from the last program-cycle is identified using an “*” at then end of the variable name, with no intervening white space. So, “count*” gives access to the value of the state variable “count” passed from the last program-cycle. “count” gives access the value to be sent to the next program-cycle. “count*” may only be read and cannot be assigned. “count” can be read and assigned. It may be read multiple times per program-cycle but may be assigned only once per program-cycle. In this embodiment state variables are initialized to zero before the first Program-cycle. In other embodiments all state variables may be initialized to one to values specified by the programmer per variable.

Lines 7 and 8 declare temporary variables whose values are lost at the end of a program-cycle. Again these variables may be read multiple times per program-cycle but may be assigned only once per program-cycle.

Those with a knowledge of synchronous digital electronic hardware design will recognize that cycle-based programs have parallels with Register Transfer Level (RTL) descriptions that are used to specify synchronous digital hardware. They will also see that a cycle-based program can be derived from code in the Synthesizable subset of a Hardware Description Language. The design must have a single clock or multiple clocks derived by dividing down one master clock. The algorithms required to derive the cycle-based program are synthesis algorithms that are well known and demonstrated in academic and commercial Electronic Design Automation tools.

FIG. 5c shows the dependencies between the pseudo-code instructions between lines 11 and 25 in FIGS. 5b. (1) & (2) represent the selections indicated by the “if” instructions. The dotted line arrow represents the execution looping back to evaluate the next program-cycle. As far as a programmer is concerned all work for one program-cycle is fully completed before the next program cycle is started. The work is carried out such that the dependencies shown in FIG. 5c are honored. The advancement from on program-cycle to the next is marked by a new program-cycle synchronization illustrated by the dotted arrow.

Some embodiments may allow completion of some work from the end of a program-cycle at the start of the next. This “borrowing” works in cases where the corresponding state variables are not needed immediately in the next program-cycle. The “borrowing” optimization is hidden from the programmer who can rely on the program functioning as though one program-cycle is fully completed before the next program cycle is started.

FIG. 5d shows how this simple test case could be partitioned into two pseudo-assembly-code sub-programs running on two processors of a multi-processor. Only two processors are needed because this is a trivial example. Real-world examples would entail hundreds, thousands or more processors with a vast amount of fine-grain communication between them.

Once a dependency graph such as the one shown in FIG. 5c has been derived for a program, known allocation and scheduling algorithms can be used to allocate instructions to processors. The example shows one of many ways that the code could have been allocated between the processors. In this example each processor executes the code in-order but in other embodiments the execution order could be determined by each processor's hardware using the techniques found in out-of-order processors and dynamic dataflow computers.

There follows a description of the pseudo assembler code two processor. This pseudo assembly code is use to demonstrate the fine-grain partitioning of the cycle-based program between the processors. This pseudo assembly code would be translated it binary-encoded machine-code instructions to be stored in the processors' memory. Often one assembler instruction corresponds to one machine-code instruction, but that is not guaranteed to be the case.

Processor 0:

Line 1: Receive a value from another processor into R0 (communication label “x_count*”)

Line 2: Set R1 non-zero if R0 is greater than 334

Line 3: Send the value in R1 to another processor (communication label “x_hit_max”)

Line 4: Multiply R0 by 3

Line 5: Add 1 to R0

Line 6: Send the value in R0 to another processor (communication label “x_count_u”)

Line 1: Set R0 to the value of the “count” state variable passed from the last program-cycle

Line 2: Send the value in R0 to another processor (communication label “x_count*”)

Line 3: Subtract 100 from R0

Line 4: Set R1 to the value of the “downward” state variable passed from the last program-cycle

Line 5: Receive a value from another processor into R2 (communication label “x_hit_max”)

Line 6: Branch to “label1” if the value in R1 is zero

Line 7: Set R3 to non-zero if R0 is less than or equal to zero

Line 8: Invert value in R3

Line 9: Unconditional branch to “label2”

Line 10: branch target label “label1”

Line 11: Set R3 to the value in R2

Line 12: branch target label “label2”

Line 13: Pass the value in R3 to the next Program-cycle in the “downward” state variable

Line 14: Receive a value from another processor into R4 (communication label “x_{—} count_u”)

Line 15: Conditional on R3 being non-zero, pass the value in R0 to the next program-cycle in the “downward” state variable

Line 16: Conditional on R3 being zero, pass the value in R4 to the next program-cycle in the “downward” state variable

Lines 6 to 12 implement the select operation labeled (1) in FIG. 5c using conditional branches to make control flow changes. But lines 15 & 16 implement the select operation labeled (1) in FIG. 5c using conditional instructions.

Most of the pseudo-code instructions are well known and used in many processors. Four instructions will be explained further: “get_state”, “put_state”, “send” and “receive”.

get_state and put_state: these pseudo instructions are for accessing state variables that pass information from one program cycle to the next. For example “get_state(count*)” gets the value of “count” passed from the previous program cycle. “put_state(count)” sets the value of count in this program cycle and to be passed to the next program cycle. Also, “get_state(count)” will get a value of count previously set in the current program cycle. So, the value of count in the current cycle and the value passed from the previous cycle can both be accessed. Using a string identifier for the state variable in the instruction (“count” in this case) is makes the assembly code easy to read and write. The assembler will allocate memory or register space as appropriate for the state variable and use the appropriate machine instructions to access the state. If the machine code can be scheduled so that all reads of “count*” in a cycle occur before the write to “count” then the value can be passed to the next program cycle simple by overwriting the register or memory location holding “count”. If the “count*” must be read after “count” is written then the in this embodiment the tools must insert code to manage taking a copy of “count*” or delaying overwriting the register or address holding “count”. In other embodiments the processor hardware directly supports updating state variables.

send and receive: these pseudo instructions are for communicating between processors. As well as the source or destination registers a label for the transaction is given in the send and receive instruction. This label identifies the intended start and end points for assembler so that it can create correct code to implement the desired transfer. Note that a “send” instruction may have more than one associated “receive” instruction.

In this embodiment the processors are connected to their nearest-neighbor using multi-bit links. In other embodiments other types of inter-processor message passing link technology and network topology are used. These include: single-bit serial links and multi-but links, links, packet-routed links in nearest neighbor, N-th neighbor, hieratical and hyper cube networks.

In this embodiment the processors communications may be routed directly between processors and the processor's inter-processor-communication hardware will autonomously pass on transfers travelling to other processors. In other embodiments communications are routed though intermediate router blocks. In other embodiments the processors inter-processor-communication hardware is not autonomous and the routing through of communications in the processor's program.

In this embodiment the transaction label is used by the assembler to align the time of send and receive instructions so they occur on separate processor at the same time. The transaction label is also used to encode the relative position of the receiving processor in the machine code performing the transmission. In other embodiments the absolute position of the receiving processor is encoded. In other embodiments another unique identifier of the receiving processor is encoded.

At receiving processor the transaction label is used to code the input channel on which to expect the communication. This embodiment aligns the time of the sending and receiving instructions making the inter-processor links simple at the cost of constraining the performance of the links by requiring them to operate in one cycle. This also puts constraints on position of instructions in the machine code relative to the start of the program-cycle. Other embodiments align transaction code in each processor with a fixed offset giving more time for the link to pass information. Other embodiments encode an offset for transactions in the machine-code instruction which relaxes the constraints on positioning of send and receive instructions. Allowing offset that are longer than the link latency adds a requirement for buffering somewhere in the processors or inter-processor link.

In other embodiments the transaction label is used to allocate a unique tag for the transaction. The tag must at least be unique across the range of time the transmission could take place and across the region of the multi-processor though which the message could pass. Tags that are unique between the sending a receiving processor can be used to identify transactions between the two processors. These are most useful for direct communications. Tags that are unique across part or all of the multi-processor can also be used to route communications through intermediate processors or routers.

FIG. 5e is a pseudo-code execution trace of two program-cycles of the cycle based program. The operations performed in each processor clock cycle are shown as is the start of each program-cycle.

In this embodiment the processor executes instruction in-order and can execute up to one communication instruction (send or receive) and one other instruction in parallel per processor-cycle. In other embodiments the processor executes one instruction per cycle. In other embodiments the processor executes other number of instructions in parallel. In other embodiments the processor executes the instructions out-of-order.

There follows a description of the activity on processor 0:

1. This instruction starts a new program-cycle in this embodiment it is aligned in the static schedule with the same instruction on processor 1. In other embodiments the instruction may not be needed with the alignment occurring implicitly on the first instruction or communication. In other embodiments the alignment occurs though a program-wide synchronization signal between processor 1 and processor 0. This in turn allows the number of processor-cycle per program-cycle to vary dynamically depending on the work required in a given processor cycle. In other embodiments the number of processor-cycle per program-cycle to vary dynamically as long as all processors running part of the program communicate enough information for them all to execute the same number of processor-cycle per program-cycle.

2. This is an empty cycle. It is required because processor 0 cannot do anything useful until it receives transmission “x_count*”. In this embodiment it is implemented using a NOP instruction that puts the processor into a power reduced state for a cycle. In other embodiments a NOP may not be needed with execution beginning at an offset from the start of the program cycle or being triggered by receiving an inter-processor communication. In a dynamic schedule this empty-cycle could be removed potentially reducing the number of processor cycles in the program-cycle or saving power at the end of the program-cycle by allowing the processor to enter an idle state at reduced power.

3. The value of transmission labeled “x_count*” is received into register R0.

4. R1 is set non-zero if the contents of R0 are greater then 334

5. The contents of R1 are transmitted labeled “x_hit_max”. The transmission instruction could execute in parallel with step 4 except that step 4 sets R1 and this embodiment does not support the necessary forwarding path to transmit a value in the same cycle it is calculated. Other embodiments may include this forwarding path.

6. The start of a multi-step instruction multiplies the value of R0 multiplied by 3

7. The multiply instruction continues

8. The multiply instruction continues

9. The multiply instruction continues

10. One is added to the contents of R0

11. The contents of R0 are transmitted labeled “x_count_u”.

12. & 13. These are empty steps because the processor has finished its work for the program-cycle and the next program-cycle has not begun. In this implementation the processor it put in a reduced power state until the start of the next cycle. In other implementations the processor may start any work it can from the next program-cycle.

14. to 26. These are the next program-cycle. The work mirrors steps 1 to 13 above.

Execution would continue iterating after the part of the pseudo-instruction trace shown.

There follows a description of the activity on processor 1:

1. This instruction starts a new program-cycle in this embodiment it is aligned in the static schedule with the same instruction on processor 0.

2. R0 is set to the value of the “count” state variable sent from the last program-cycle

3. The value in R0 is sent to another processor with transaction labeled “x_count*”. In parallel 100 is subtracted from R0. The value of R0 before 100 is subtracted is transmitted.

4. R1 is set to the value of the “downward” state variable sent from the last program-cycle

5. The value of transmission labeled “x_hit_max” is received into register R2

6. Branch not taken—in this example we assume R1 is not zero this cycle.

7. R3 is set non-zero if the value in R0 is less than or equal to 0

8. if R3 is zero it is set non-zero, if R3 is non-zero it is set to zero

9. Unconditional branch (unconditional so no branch penalty)

10. The value in R3 is stored in the sate variable “downward” to be passed to the next program-cycle

11. The value of transmission labeled “x_count_u” is received into register R4

12. if R3 is zero the value in R0 is stored in the sate variable “count” to be passed to the next program-cycle

13. if R3 is non-zero the value in R4 is stored in the sate variable “count” to be passed to the next program-cycle

14. This instruction starts a new program-cycle

15. as cycle 2

16. as cycle 3

17. as cycle 4

18. as cycle 5

19. Unlike the previous program cycle, this time the branch is taken

20. unused cycle penalty due to taking the conditional branch

21. R3 is set to the value held in R2

22. The value in R3 is stored in the sate variable “downward” to be passed to the next program-cycle

23. This is an empty cycle. It is required because processor 0 cannot do anything useful until it receives transmission “x_count_u”

24. as cycle 11 (The value of transmission labeled “x_count_u” is received into register R4)

25. as cycle 12

26. as cycle 13

Execution would continue iterating after the part of the pseudo-instruction trace shown.

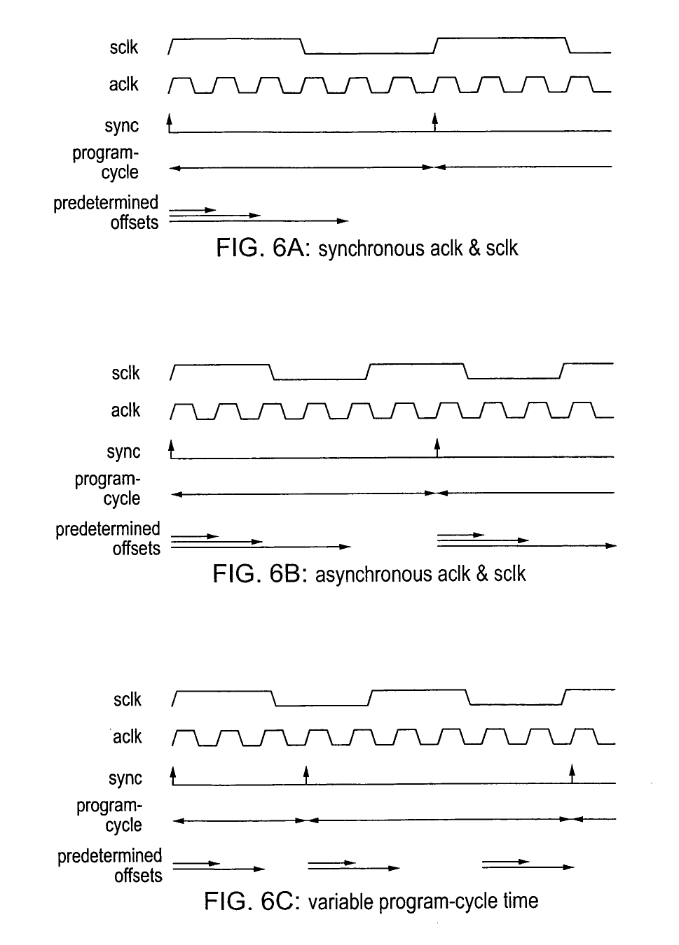

FIGS. 6a, 6b and 6c schematically illustrates the relationship between the system clock signals sclk, the array clock signals aclk and the program-cycle. As will be seen, the system clock signal sclk has a lower frequency than the array clock signals aclk. The rising edge of the system clock signal sclk can be used to define the boundary of the program-cycle and provide a synchronisation point between the processing being performed by each of the processors 26. Each of the processors may be arranged to have completed the execution of its program by the time the program-cycle has completed, as indicated by the start of the next cycle of the system clock sclk. These synchronisation times provide an opportunity for communication between the processors 26 of the array 10. Communication may also take place within the array at predetermined offsets from these synchronisation times as is illustrated. Intra-array communication during program-cycles may improve efficiency with two or more processors 26 being able to cooperate more effectively.

Also illustrated in FIG. 6 is an evaluation cycle. This program-cycle is shown as having a variable duration and accordingly is not limited to any fixed relationship with the system clock signal sclk. It is the boundary between program-cycles which defines the synchronisation time for the processing operations performed by the array 10. In a subset of circumstances, the boundary between program-cycles will also be the boundary between cycles of the system.

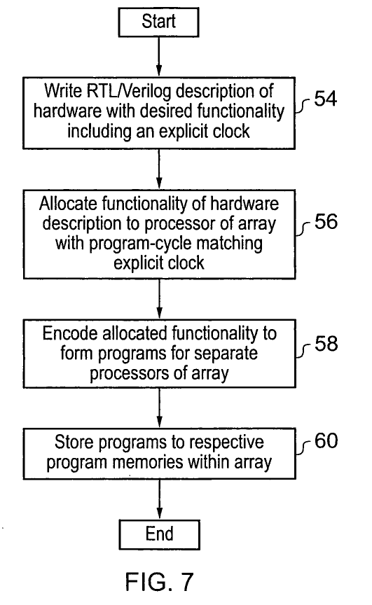

FIG. 7 schematically illustrates a flow diagram illustrating the programming of the array 10. At step 54 a programmer writes a register transfer level Verilog hardware description or a synthesisable Verilog hardware description of hardware with the desired functionality to be provided by the array 10. This hardware description includes an explicit clock. The hardware description is then supplied to a logic synthesiser which allocates (step 56) which functionality of the hardware description is to be provided by which processor 26 within the array 10. The partitioning is performed such that the program-cycle of the processors 26 within the array matches the explicit clock within the hardware description. At step 58, the software encodes the allocated functionality for each processor 26 into program instructions for that processor 26 which will control that individual processor 26 to achieve the desired functionality within the program-cycle, i.e. generate starting from its required input state variables the next state of the output state variables for which it is responsible. At step 60, the separate programs for the individual processors 26 are stored within the memories 32 of the individual processors 26 within the array 10.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

1. An integrated circuit for data processing, said integrated circuit comprising:
an array of interconnected processors, each processor having a memory storing a program defining a set of processing operations to be performed by said processor;
further processing circuitry responsive to a system clock signal to perform synchronous processing operations; and
interface circuitry coupled to said array and to said further circuitry to provide communication of one or more signals between said array and said further processing circuitry such that data processing operations of said integrated circuit are distributed between said array and said further processing circuitry; wherein
said programs stored within said memories of said array together define a plurality of sets of processing operations to be performed by said processors of said array such that said array is configured to execute a cycle-based program;
said cycle-based program provides state variables that allow results of operations executed in one program-cycle of said cycle-based program to be accessed during a subsequent program-cycle of said cycle-based program; and
during each program-cycle of said cycle-based program, each of said processors of said array executes a respective program starting from a predetermined execution start point to evaluate a next state of at least some of said state variables, a boundary between program-cycles providing a synchronisation time for processing operations performed by said array.

2. An integrated circuit as claimed in claim 1, wherein said interface circuitry includes a bus interface unit coupled to a synchronous clocked bus of said further processing circuitry.

3. An integrated circuit as claimed in claim 1, wherein said interface circuitry includes an bus interface unit coupled to an asynchronous bus of said further circuitry.

4. An integrated circuit as claimed in claim 1, wherein said interface circuitry includes handshake circuitry to provide said communication in accordance with a handshake protocol.

5. An integrated circuit as claimed in claim 1, wherein said interface circuitry is responsive to a signal from said array to be communicated to said further processing circuitry to maintain a signal level of a signal being passed to said further processing circuitry at a corresponding level for a predetermined number of cycles of said system clock signal.

6. An integrated circuit as claimed in claim 1, wherein said interface circuitry is responsive to a signal from said array to be communicated to said further processing circuitry to alter a signal level of a signal being passed to said further processing circuitry after a predetermined number of cycles of said system clock signal.

7. An integrated circuit as claimed in claim 1, wherein said interface circuitry includes; and/or circuitry that samples a signal from said further processing circuitry at a predetermined time relative to said synchronous clock signal and then passes said signal to said array synchronised with a clock signal of said array.

8. An integrated circuit as claimed in claim 1, wherein one or more signal are passed between said processors of said array at times having a predetermined timing relative to a start time of each program-cycle.

9. An integrated circuit as claimed in claim 1, wherein at least one of said programs executed by said processors of said array includes at least one branch program instruction.

10. An integrated circuit as claimed in claim 1, wherein at least one of said programs executed by said processors of said array includes variable length instructions.

11. An integrated circuit as claimed in claim 1, wherein at least one of said programs executed by said processors of said array includes instructions taking different numbers of processing cycles to execute.

12. An integrated circuit as claimed in claim 1, wherein said processors of said array execute said programs under control of an array clock signal having a higher frequency than said synchronous clock signal.

13. An integrated circuit as claimed in claim 1, wherein said program-cycles of said array are synchronised with said synchronous clock.

14. An integrated circuit as claimed in claim 1, wherein said program-cycles of said array have a variable duration and said interface circuitry provides communication with said further processing circuitry that is synchronised with said synchronous clock.

15. An integrated circuit as claimed in claim 1, wherein at least one or said processors of said array provides a multi-bit data pathway for processing a multi-bit data value.

16. An integrated circuit as claimed in claim 1, wherein said interface circuitry provides communication between said array and said further processing circuitry via a system bus open to communication not involving said array.

17. An integrated circuit as claimed in claim 1, wherein said interface circuitry provides communication between said array and said further processing circuitry via a private bus dedicated to communication between said array and said further processing circuitry.

18. An integrated circuit as claimed in claim 1, wherein said programs for said array are machine generated from a machine readable hardware description of hardware having functionality to be provided by said array.

19. An integrated circuit as claimed in claim 18, wherein said machine readable hardware description is one of register transfer level Verilog and synthesisable Verilog.

20. An integrated circuit as claimed in claim 1, wherein said memory of said processors are rewritable such that said programs can be changed after manufacture of said integrated circuit.

21. An integrated as claimed in claim 1, wherein said further processing circuitry comprises one of more of:
a general purpose program controlled processor;
a digital signal processor;
a non-programmable processing engine; and
a memory.

22. A method of programming an integrated circuit having an array of interconnected processors, each processor having a memory storing a program comprising a set of processing operations to be performed by said processor, and further processing circuitry responsive to a synchronous clock signal to perform synchronous processing operations, said method comprising the steps of:
generating a synthesisable hardware description with at least one explicit clock signal to perform desired processing;
mapping said hardware description to a plurality of programs each defining a set of processing operations to be performed by a processor within said array; and
storing said plurality of programs in respective program memories within said array such that:
said array when executing said plurality of programs executes a cycle-based program corresponding to said desired processing described in said hardware description;
said cycle-based program provides state variables that allow results of operations executed in one program-cycle of said cycle-based program to be accessed during a subsequent program-cycle of said cycle-based program; and
during each program-cycle of said cycle-based program, each of said processors of said array executes a respective program starting from a predetermined execution start point to evaluate a next state of at least some of said state variables, a boundary between program-cycles providing a synchronisation time for processing operations performed by said array.

23. An end-user device including an integrated circuit for data processing, said integrated circuit comprising:
an array of interconnected processors, each processor having a memory storing a program defining a set of processing operations to be performed by said processor;
further processing circuitry responsive to a synchronous clock signal to perform synchronous processing operations; and
interface circuitry coupled to said array and to said further circuitry to provide communication of one or more signals between said array and said further processing circuitry such that data processing operations of said integrated circuit are distributed between said array and said further processing circuitry; wherein
said programs stored within said memories of said array together define a plurality of sets of processing operations to be performed by said processors of said array such that said array is configured to execute a cycle-based program;
said cycle-based program provides state variables that allow results of operations executed in one program-cycle of said cycle-based program to be accessed during a subsequent program-cycle of said cycle-based program; and
during each program-cycle of said cycle-based program, each of said processors of said array executes a respective program starting from a predetermined execution start point to evaluate a next state of at least some of said state variables, a boundary between program-cycles providing a synchronisation time for processing operations performed by said array.

24. A method of providing an in-field update to functionality of an integrated circuit having an array of interconnected processors, each processor having a memory storing a program comprising a set of processing operations to be performed by said processor, and further processing circuitry responsive to a synchronous clock signal to perform synchronous processing operations, said method comprising the steps of:
generating a synthesisable hardware description with at least one explicit clock signal to perform desired processing;
mapping said hardware description to a plurality of programs each defining a set of processing operations to be performed by a processor within said array; and
storing said plurality of programs in respective program memories within said array such that:
said array when executing said plurality of programs executes a cycle-based program corresponding to said desired processing described in said hardware description;
said cycle-based program provides state variables that allow results of operations executed in one program-cycle of said cycle-based program to be accessed during a subsequent program-cycle of said cycle-based program; and
during each program-cycle of said cycle-based program, each of said processors of said array executes a respective program starting from a predetermined execution start point to evaluate a next state of at least some of said state variables, a boundary between program-cycles providing a synchronisation time for processing operations performed by said array.

25. An integrated circuit for data processing, said integrated circuit comprising:
array means of interconnected processor means, each processor means having memory means for storing a program defining a set of processing operations to be performed by said processor means;
further processing means responsive to a synchronous clock signal to perform synchronous processing operations; and
interface means coupled to said array means and to said further means to provide communication of one or more signals between said array means and said further processing means such that data processing operations of said integrated circuit are distributed between said array means and said further processing means; wherein
said programs stored within said memory means of said array means together define a plurality of sets of processing operations to be performed by said processor means of said array means such that said array means is configured to execute a cycle-based program;
said cycle-based program provides state variables that allow results of operations executed in one program-cycle of said cycle-based program to be accessed during a subsequent program-cycle of said cycle-based program; and
during each program-cycle of said cycle-based program, each of said processor means of said array means executes a respective program starting from a predetermined execution start point to evaluate a next state of at least some of said state variables, a boundary between program-cycles providing a synchronisation time for processing operations performed by said array means.
